(19) United States
(12) Patent Application Publication
(10) Pub. No.: US 2024/0029100 A1
(43) Pub. Date: Jan. 25, 2024

(54) INCENTIVE AWARDS DENOMINATED AS SHARES OF EQUITY

(71) Applicant: Peter Christopher John Gallagher, Newtown Square, PA (US)

(72) Inventor: Peter Christopher John Gallagher, Newtown Square, PA (US)

(21) Appl. No.: 18/339,871

(22) Filed: Jun. 22, 2023

Related U.S. Application Data
(60) Provisional application No. 63/355,621, filed on Jun. 26, 2022.

(51) Int. Cl. G06Q 30/0207

(52) U.S. Cl. CPC G06Q 30/0216; G06Q 30/0224

(57) ABSTRACT

Prosesses and apparatus to operate an incentive award program wherein a Business Entity establishes a wholly owned Company that conducts essentially no other business than providing shares of its equity to recipients of said awards who have made purchases from it. Thereby, a pure positive feedback loop is generated that can scale indefinitely: Additional Paid-In Capital flows to the Company, its share price increases from so operating profitably whereby additional recipients are incentivized to transact and yet more profits result causing even more recipients to transact. Operation of the program is detailed in several different market sectors. Early adopters of the program particularly benefit by their holdings of shares being marked-to-market as the Company's share price escalates. Recipients can sell their shares at then market value where the Company's shares trade.

### CROSS-REFERENCE TO RELATED APPLICATION AND PATENT

This U.S. patent application claims priority to Provisional Patent Application 63/355,621 filed Jun. 26, 2022.

The present patent application discloses improvements over my U.S. Pat. No. 7,219,071 issued May 15, 2007. The disclosures of U.S. Pat. No. 7,219,071 (the “'071 patent”) and the aforesaid Provisional Patent Application are incorporated by reference herein.

### BACKGROUND

The '071 patent described in broad terms the original and useful methods, systems and apparatus of granting incentive awards denominated as shares of equity. It also described certain narrow and specific applications of such technique. The present application teaches and claims improved, enhanced and new, original utility to the granting of incentive awards denominated as equity. Furthermore, it dispenses with several elements of the '071 patent, thereby significantly improving the business functionality of the present application.

Claims of the issued '071 patent were limited by the presence of the formula Fₙ=F₁Rⁿ⁻¹—a factor that is not present in this application. That issued patent presented a very broad range of businesses, the equity in which was listed as available for being provided as incentive awards. The present improved application claims that the incentive awards will be denominated as shares in a ‘Company’, specifically, a wholly owned subsidiary of the Business Entity, the entity that owns and operates the incentive awards program of the present invention. While the '071 patent teaches that the awards can be in ‘a tracking company’ therein is a complete absence of the details that, by contrast, function most successfully to enable ‘The Company’ in the present invention to power the enduring pure positive feedback loop herein disclosed.

It is recognized by the present applicant that novel and useful elements herein are commingled in the present disclosure with material that is prior art in issued U.S. Pat. No. 7,219,071. Teachings herein that are distinctly patentable and break new ground. Examples, without limit thereby, include the novel market sectors that are not presently served by any kind of incentive awards program: notably, Traditional and Roth IRAs, Type 529 Savings Programs and Shared Profit Transactions involving incentive awarded shares. A further example is the introduction of a Technical Operations entity to significantly reduce the operating cost and effort of the Company.

Described in detail herein and not present in the prior art, are the processes and apparatus whereby the present invention generates an enduring pure positive feedback loop. A key principle of the present invention is the detailed provision of means to ensure not only profitability of ‘The Company’ but the important consequence, namely, that its trading unit share value will increase indefinitely. The present application teaches and claims a new means of achieving this goal: the Business Entity establishes, staffs, funds and maintains a Technical Operations function that is in charge of all communications and computer-related activity of the Company as well as the Business Entity's own like requirements. As listed in Table 5 of this document, provided within the Incentive Awards Program are far reaching services that enable the recipients of awards to beneficially manage the incentive awards they have received. The essential requirement of profitable operations of the Company is significantly enhanced by its access to the Technical Operations function. At its discretion, the Business Entity may establish this Technical Operations Division within its own business organization, establish an additional wholly owned business enterprise or in any other fashion it may choose.

### BRIEF DESCRIPTION OF THE DRAWINGS

FIG. 1 Schematic of the Process of the enduring pure positive loop

FIG. 2 Business Entity registers with SEC & FINRA to launch Awards Process

FIG. 3 Business Entity establishes Wholly Owned Company, launches Process in Vehicle sector

FIG. 4 Business Entity contracts with Enterprises to grant Licenses to operate Process

FIG. 5 Drawing of contrasting outcomes of positive and negative feedback loops

FIG. 6 Process details in six additional market sectors

FIG. 7 Schematic diagram of financial flows in the awards Process

FIG. 8 Custom technical devices to operate the Process in the credit card market

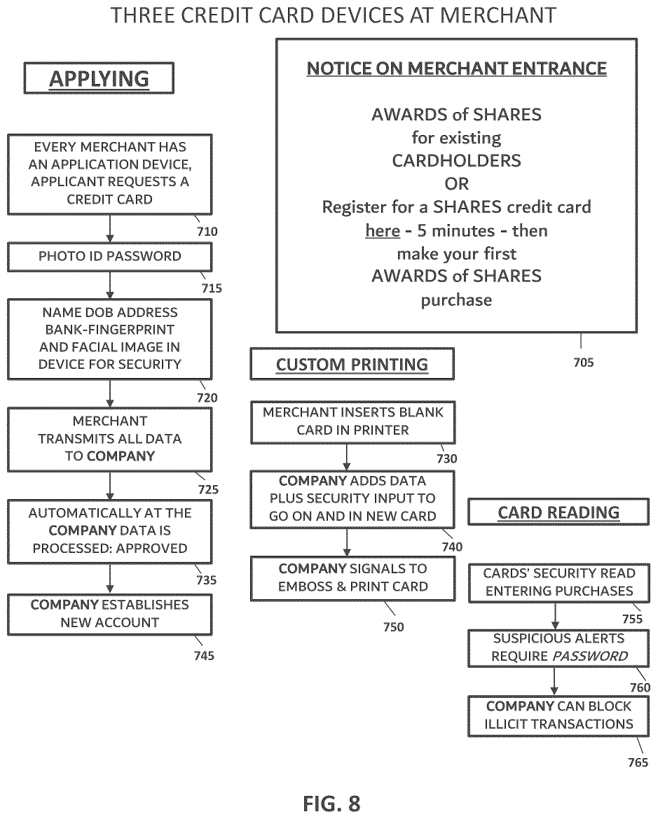

FIG. 9 Technical Operations apparatus included in Business Entity and Company Processes

### DETAILS OF THE INVENTION

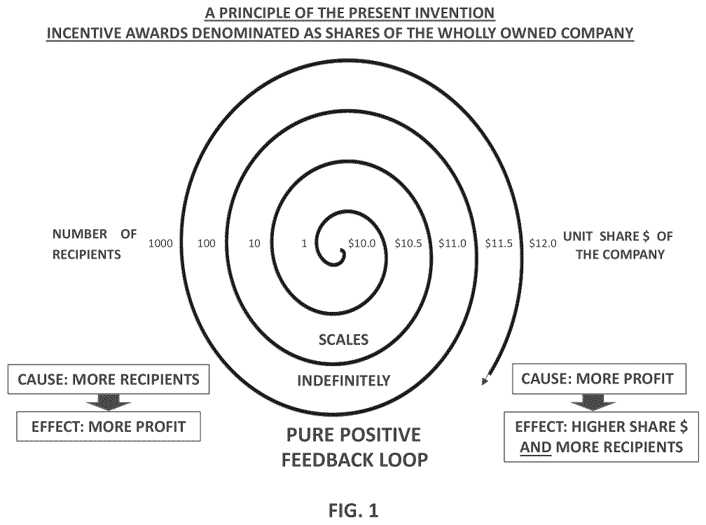

FIG. 1 illustrates ‘A Principle of The Present Invention, Incentive Awards Denominated as Shares of the Wholly Owned Company’. Depicted are the sequence of events that comprise a pure positive feedback loop that is designed to scale indefinitely. The basic requirement for a positive feedback loop is that a cause generates a positive effect and this caused positive effect itself causes a second positive effect to the original cause. Thereby, a positive feedback loop—positive cause 1/positive effect 1/positive cause 1 again/positive effect 1 again/to operate indefinitely. As illustrated in FIG. 1, the Business Entity launches an incentive program wherein its wholly owned Company grants shares of its own equity as awards from sales made to customers by the Business Entity. The attractiveness of the program granting shares of equity as rewards leads to a substantial, ever-increasing number of awarded recipients and the Business Entity profits from an increase in market share. The Company benefits from low cost of running its business by reason of Technical Operations services provided free-of-charge by the Business Entity, thereby the Company operates profitably. The awards being granted as shares of equity, rather than cash, attract recipients to participate in the incentive program. Each awarded transaction involves the Company selling shares of its equity to recipients, equal in value to the award's cash equivalent. Profit in the form of Additional Paid-In Capital accrues to the Company from each transaction. Additional income to the Company is anticipated by receipt of a per-transaction administration fee. The effect of each awarded transaction causing profit to the Company is that its trading unit share price will be caused to gradually increase. The share price will be public knowledge and the effect of its higher value will be to cause more transactions. Thereby, as illustrated as an ongoing spiral in FIG. 1, the outcome is for the number of recipients and the unit share value of the Company to be the repeated cause/effect outcome of a positive feedback loop. So as not to disturb the outcome, the Company conducts no other business than herein described. Accordingly, the method is pure in that there are no other business factors to affect the outcome. The method is designed to function for as long as the Company has shares to provide as incentive awards. Planned is to capitalize the Company with a very large number of Authorized Shares which can be Issued as necessary. It is also contemplated that the Company can authorize additional shares as is common business practice. An original business alternative would be to retire the Company and replace it with a Newly Established Company that will perform the same function. Thereby, through unlimited availability of shares, it is planned for the present invention to endure—that is, to scale indefinitely.

A notable feature of the present invention is that early adopters as awarded recipients will benefit from the increased unit share trading value of their existing holdings of the Company's shares as its unit share trading price increases. Every new recipient causes profit to the Company and an increase in its unit share trading price. A result for everybody holding awarded shares will be daily pleasure when seeing how the worth of their account increases. An important outcome for the program is that existing recipients will generate powerful word-of-mouth encouragement to others to become recipients. They will likely proselytize complete strangers—not only friends and family.

As business examples, McDonalds and Walmart have both prospered for a very long time—though not by means of a positive feedback loop. Both have grown year by year from opening additional business sites: McDonalds, in the U.S. and internationally and Walmart by opening additional stores, mainly in the U.S. Feedback from our overseas market research is that the present program is understood and welcomed everywhere.

A major positive of the business of granting such unique incentive awards is that it can prosper in virtually every business sector in the world. Rather than simply dominating a single business sector worldwide it can be profitably present in almost all business sectors worldwide.

Our research has revealed that recipients of incentive awards would love to receive rewards of equity—shares in some company or other—that would provide excitement and at least a chance of gain beyond simply cash. In the long term, simply equity in any company might, foolishly, satisfy these individuals risk/reward desire but realistically could lead to losses as well as gains. Clearly, a very positive development is awards of equity in a Company wherein the unit market share price never decreases. Present invention addresses this bountiful prospect and is expected to make a desired possibility into a reality. The present invention achieves this goal by applying a pure positive feedback loop method. A special benefit is having a Technical Operations unit that minimizes the Company's operating costs and designs and operates valuable Apps that are available to awards recipients.

The present invention is designed to gain market share in almost all business sectors, but the applications cited have been selected to enable substantial penetration at minimal cost and passage of time, by focusing on financial sectors so as to minimize expansion of bricks and mortar infrastructure, thereby providing business success without the need for major innovation of apparatus yet the Technical Operations function will develop as much cutting-edge apparatus innovation as will be required, particularly in communication and computer-electronics.

Pre-Start-Up

In detailing the method of the present patent application it is relevant to discuss the pre-start up procedure. This Intellectual Property will be offered for sale, as is. The assignee will likely be the highest qualified bidder and will recognize that purchasing the patent application involves a significant engagement with the USPTO to be awarded all or some or no issued business patent rights.

There is no ‘team’ in place to implement start up. There are no funds in place, no Business Entity, no Company.

The new Owner of the patent application (or Rights if patent is issued before sale) will be responsible for launching a major business that has worldwide potential. Is it likely that a U.S. entity will be the acquirer?

It is probable that the assignee will have very substantial wealth, will connect with the best financial business planners, will have Intellectual Property experience and will already have enterprises in place worldwide. Accordingly, it is possible that a major Sovereign Investment Fund will be one type of organization has the necessary criteria.

A website, www.swfinstitute.org lists such entities in the world. Of the ten largest Sovereign Investment Funds, 5 are Asian, 4 are Middle Eastern, Norway is the only one in Europe and none are U.S. All of them have investments in companies that operate in multiple countries worldwide, including in the U.S.: for instance, the Singapore Sovereign Fund holds a position in Synchrony Financial (Ticker SYF), a U.S. company with 16,500 employees and $15 billion annual revenue. It is the largest private label credit card business in the U.S. and has positions in auto market sectors. Thereby, possibly a candidate as the Business Entity of the present invention.

If these entities seek to purchase the present Intellectual Property it is unlikely that they will be outbid—the largest has $1,350 billion wealth, the 10^{th} largest $447 billion.

Given the broad range of corporate entities worldwide in which these Funds hold positions it is possible that a Business Entity and a wholly owned Company could be established essentially simultaneously in a number of nations in which start-up operations could span many market sectors.

If this Intellectual Property is not valued highly by prospective acquirers the range of bidders could be far wider. Many U.S. companies and others overseas seek to acquire a major diversification. Also, private equity funds thrive by investing in promising business opportunities.

Process and Apparatus of the Incentive Awards Program

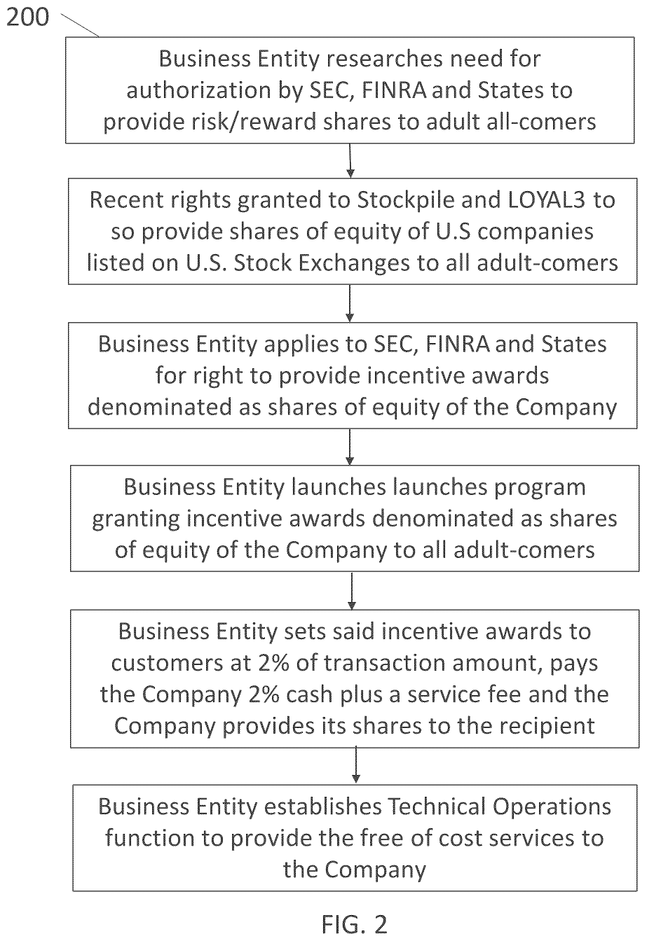

For the program of the present invention to provide incentive awards of risk/reward shares of investment to all-comers in the U.S. it must be granted regulatory approval by the SEC, FINRA and, as may be applicable, some local jurisdictions. While it is anticipated by present inventor that shares of the Company will be ‘no-risk’ the process of the present program must be granted approval. FIG. 2 states 200 that a first step for the Business Entity 205 will be to determine the regulatory requirements and to be granted the right to operate as planned.

An early example of a program that did provide risk/reward shares to all-comers was Stockback some 25 years ago. This company operated an awards program limited to sales to customers of several well-established U.S. businesses including Ford Motor Company. The rewards were denominated in cash—but, customers could, twenty dollars investment at a time, purchase a risk/reward entity made up of shares of each of the participating businesses in the program. The program failed after a couple of years because the provided risk/reward award failed to increase in value over time at an attractive rate. The awarded equity was in the performance of the shares of a group of businesses rather than the valuable performance of the awards program itself as in the present invention.

Until quite recently, U.S. regulations were reluctant to expose all-comers, many with little investing experience, to access shares of equity other than through licensed brokers. For a few years now, access has been more available 210. Two companies, Stockpile and LOYAL3 are in business providing gift cards and other means of access, to own equity in risk/reward investments. Promotional material of these companies online specifically solicits sales to ‘beginners’. Stockpile in an early 2023 advertisement stated that ‘over 300,000 gift cards that granted ownership of risk/reward shares in many U.S. companies’ had been sold. Some cards allowed the purchaser to name the risk/reward shares of any company when using their purchased gift cards.

Accordingly, applications will be made 215 and it is anticipated by inventor that the present program will be granted regulatory approval, including issuance of a broker license. Both the Business Entity and the Company will be subject to regulatory oversight, just as the cited operating companies here mentioned, are. Both the Business Entity and the Company will comply with requirements for full disclosure of their business activities as required by law.

Open for all to see will be the minute-by-minute trading price of the publicly traded shares. As described in FIG. 2 the Business Entity will be able to put in place the infrastructure of the present invention. The Company will be established 220 as a wholly owned company of the Business Entity. Incentive awards of cash in already existing by others are typically 2% of the value of the rewarded purchase and this is a natural provision 225 to make in the Business Entity's new program.

A feature of the new program is that the Company will establish an account on its website for each recipient of its shares. Each transaction will involve the Business Entity paying the Company the 2% cash value of the shares it grants per transaction to recipients. Said payment by the Business Entity to the Company will be recorded on its books under the heading ‘Equity’ as Additional Paid-In Capital. The entire sum so entered is as available for expenditure by the Company (to pay expenses, etc) as is the original capital worth when the Company was established. As indicated in FIG. 2 225, the Business Entity will also pay the Company a service fee to cover the cost of administering the transaction. A benefit to the Company—in minimizing its operating costs—as indicated in FIG. 2 230 is that the Technical Operations function will be funded by the Business Entity at no cost to the Company.

Start-Up of the Present Process in a Single Market Sector

There are several ways in which the process of the present invention can commence operations. Definitions are now provided. The starting point is that the rights to the present invention are assigned by inventor to a party. This party is designated as Owner. The Owner can be the Business Entity that launches and operates said incentive award program and that establishes said wholly owned Company. In this instance it is likely that the Owner will already operate a business and will elect to launch said program in this market sector. The present application has identified the vehicle financing business as a promising start up sector. The Owner may be operating a business in a different market and may elect to launch the program there. The Owner could very well be a party that sees the present invention as a valuable investment. Examples abound: an equity fund operator, a large pension fund, a sovereign trust fund, a bank or any number of large businesses that seek a substantial diversification. The Owner could be an enterprise that launches the program by licensing operating rights to numerous entities, very probably each entity in a different market sector or geographical region. It is possible that a consortium of several organizations will share ownership of the rights to the program. Warren Buffet is always looking for ‘elephant-sized’ acquisitions but prefers bargains that do not involve patents!

Without limit, the present application covers every possible style of ownership. As a matter of definition, the term Business Entity will be used to mean the actual Operator of the present intellectual property and said Business Entity will establish said wholly owned Company to conduct essentially no other business than providing shares of its equity to recipients of incentive awards as claimed in this patent application. It will also establish, fund, staff and operate a Technical Operations unit devoted to providing communication and computer services as well as all other technical services, both for itself—and, free of cost, to the Company.

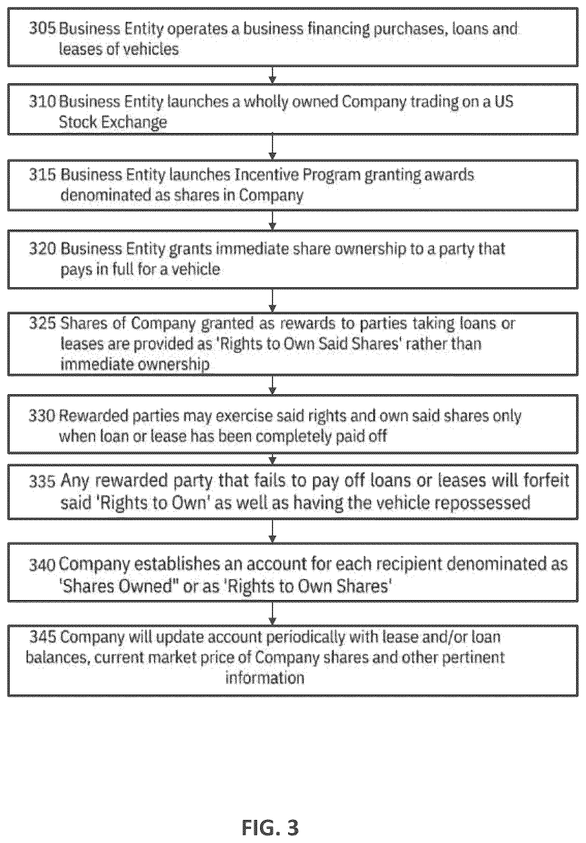

In FIG. 3, item 305 illustrates the steps involved in launching the program in the chosen market sector, that of financing purchases, leases and loans of vehicles. A very considerable sum of money will be needed to finance a major gain in market share in the vehicle financing market sector. For autos alone it is a $20 billion/year market. Outstanding debt in the sector is more than $1.3 trillion. This single sector is the third largest source of debt in the U.S. Over 80% of new autos are financed, 30% as leases. Essentially every auto manufacturer, overseas as well as domestic, that sells its new cars in the U.S. is a provider of financing. Several banks and credit unions have sizable positions in the market. Additionally, some financing companies specialize in this market sector.

Business Entity 310 establishes a wholly owned Company whose shares of equity will be granted as incentive awards. Ideally, the Company will trade publicly on, for instance, the Nasdaq Exchange. Transparency of operations is achieved thereby—everybody will have access to full accounting details. Plus, the daily transactions will advertise the strength of the performance of the unit share value of the equity in the Company granted as incentive awards. A possible negative of listing on a public exchange is the risk of exposure to an organized, large scale short selling or other harmful interference in the planned method of operation. Accordingly, a private trading platform may regretfully be put in place. This would reduce transparency, and also involve a considerable extra burden of effort, but would minimize the possibility of outside interference in operation of the incentive award program.

The Business Entity 315 launches the incentive program in the vehicle financing market sector. This sector has many business advantages. Firstly, it does not have in place strong, organized award programs—unlike the many retail markets that are replete with cash-back credit card plans. A modest benefit presently vehicle purchasers within the market is that they can sometimes negotiate for added features in their new cars—upgrades.

The vehicle financing business sector has several additional pluses for all concerned in the planned new program. On average, each lease or loan contract is for at least $30,000 and for as much as $50,000. Preparing contracts takes little effort—they are usually for 5 years and differ hardly at all one from another. While the contract is in place very little communication is needed with clients—unlike, for instance, the dozens of individual transactions recorded in most every monthly credit card statement.

Parties who buy a vehicle and pay in full upon delivery 320 will be awarded immediate ownership of shares in the Company. These shares will be listed in the newly established on-line account that is provided for the recipient by the Company. The shares may remain there until such time as the client chooses to sell them on the market where they trade.

In FIG. 3, item 325 details are provided of how parties who take out a loan or a lease to take possession of a new or used vehicle are granted incentive awards within the present incentive program. As is well-known, the vehicle of a client who defaults on a loan or lease is—repossessed! This is a strong incentive for clients to keep making loan/lease payments on time and an important security factor for the lender. An original method of the present method having considerable utility is for the incentive program to award ‘a right to own shares’ that can only be exercised when financing is paid off in full. Providing such restricted shares yields an additional incentive for financing to be paid off in full—particularly since the shares that are lost along with the vehicle are likely to have increased in value.

The program is launched 330 with said restricted shares of the Company being provided to recipients of loans and leases. It is expected that recipients in the program will not be deterred from accepting the terms of their contract 335 that they cannot sell shares until their debt has been cleared and that they will lose their expected restricted shares if they default. Just as an account is established for all award recipients by the Company, 340 included are clients with loan/lease funding. Once cleared of restriction, the shares may be held for as long as the client so chooses. However, a condition is that for all clients, once their awarded shares are sold the cash proceeds may not be allowed to be traded further on the personal site provided by the Company to each client. Rather, the funds will be denominated as cash until the client chooses to make a partial or complete withdrawal.

The Company will update said accounts periodically 345 current market price of Company shares, the value of holdings of shares and cash along with other pertinent information. For instance, included will be the cost basis of each holding of shares, information that will facilitate the completion of tax records when shares are sold. Recipients holding shares that are free from restriction will be free to sell them 350 on the site where shares of the Company are traded 355.

TABLE 1 lists data relevant to introduction of the present program in the vehicle financing sector, drawn from a 10Q Filing by Tesla. Compared are Revenues and other financials for 9-month periods ended Sep. 30, 2021 and 2022. In this one company alone over $46 billion Auto Sales were achieved in 2022 with a Gross Profit Margin of 27.3%. Even though 80% of the auto industry sales overall are financed, Tesla's Leasing Revenue in 2022 was only $1.877 billion, suggesting that there is an opportunity for their present program to generate substantial gains, for instance, by introducing an incentive awards program. Leasing provided a 38.4% Gross Margin—an indication of the lesser cost of financial business compared to manufacturing. Net Income for the 9 months ended September 2022 was only $8.88 billion, indicative of the major costs involved in operating a growing auto manufacturing business.

Because of its relevance to the method of the present patent application, Tesla's holdings of Additional Paid-In Capital (APIC) are listed in TABLE 1. It is notable that substantial APIC holdings are common in many U.S. businesses, including Tesla: As of Sep. 30, 2022 Tesla's APIC was over $31 BILLION. It is notable that APIC is not dormant—in Table 1 Tesla's APIC increased by $1.789 billion from September 2021 to a year later. An increase in APIC will typically arise from shares of equity having been sold to various parties. A decrease will typically indicate that funds have been withdrawn from APIC to pay expenses, to make investments or to satisfy other costs of doing business.

In the present invented method, much of the income of the program originates as APIC. This new method will be a successful, novel extreme example of a circumstance that occurs to positive effect in most U.S. companies.

TABLE 1
TESLA FINANCIALS (in millions, unaudited)
(Selected data period 9 months ended September 2021 and 2022
from 10Q Filing)

| | Nine Months Ended September 30 | | | |
|---|---|---|---|---|
| | _{——}2022_{——} | | _{——}2021_{——} | |
| REVENUES | | | | |
| Automotive Sales Revenue | $46,969 | | $29,100 | |
| Cost of Automotive Sales | 34,166 | | 21,726 | |
| GROSS PROFIT AUTO | 12,803 | 27.3% | 7,374 | 25.3% |
| SALES | | | | |
| Automotive Leasing Revenue | $1,877 | | $1,014 | |
| Cost of Automotive Leasing | 1,157 | | 582 | |
| GROSS PROFIT AUTO | 720 | 38.4% | 432 | 42.6% |
| LEASING | | | | |
| NET INCOME ALL | $8,880 | | $3,301 | |
| AUTOMOTIVE | | | | |
| EQUITY | | | | |
| Additional Paid-In Capital | $31,592 | | $29,803 | |

| | |
|---|---|
| INCREASE IN | $1,789 year-to-year |
| ADDITIONAL | |
| PAID-IN CAPITAL | |

TABLE 2 lists estimated expected benefits to a typical auto financing business from introducing the method of the present incentive award program over a 4-year period after inception at the start of year 1.

Some lessees will switch to buying a vehicle from the operator of the incentive program. This benefit is not recorded in Table 2 because a buyer's brand preference is likely to prevail in many cases.

However, it is anticipated that the incentive program will cause financing business to flow to it.

The upper section of TABLE 2 estimates sources of income that will benefit the incentive program operator (Business Entity) and the Company, its wholly owned partner.
Additional sales of leases/loans
Income to Company of 2% as APIC
Extra Income from charging 1 extra point APR (say 6% not 5%)

It is conjectured that the offer of a powerful incentive, in addition to increasing financing sales and APIC income to the Company, will enable the interest rate charged on leases/loans to be 1 point higher: the example raises the Annual Percentage Rate of Interest by one percentage point, from 5% to 6%.

TABLE 2
ESTIMATED BENEFIT FROM INCENTIVE
PROGRAM IN AUTO LEASING

| | YEAR | | | |
|---|---|---|---|---|
| MILLIONS $ | 1 | 2 | 3 | 4 |
| Estimated Annual Auto Leasing | 2,000 | 3,000 | 4,000 | 5,000 |
| without Incentive Program | | | | |
| Estimated Leasing Additional | 500 | 1,000 | 1,500 | 2,000 |
| Growth With Incentive Program | | | | |
| of 2% Equity on Sales of | | | | |
| COMPANY shares | | | | |
| ESTIMATED TOTAL SALES | 2,500 | 4,000 | 5,500 | 7,000 |
| CALCULATED INCOME OF | 50 | 80 | 110 | 140 |
| COMPANY FROM 2% ADDI- | | | | |
| TIONAL PAID-IN CAPITAL | | | | |
| Extra Income to Business Entity | 200 | 400 | 550 | 700 |
| (By charging 1 extra % Point | | | | |
| Interest (e.g. APR 6% not 5%) | | | | |

$ NOT MILLIONS OF DOLLARS
Estimated Worth of 2% Reward of $1,000
On $50,000 Loan/Lease After 5 years

| | | |
|---|---|---|
| AT ANNUAL INCREASE in COMPANY | +50%/YEAR | $7,594 |
| SHARE PRICE | +100%/YEAR | $32,000 |

Number of COMPANY Shares for $1,000 Incentive Award

| | | | | |
|---|---|---|---|---|
| Unit Market Share Price $ | 100 | 200 | 400 | 800 |
| Number of Shares | 10 | 5 | 2.5 | 1.25 |

The incentive program's advertisements may state:

BUY OUR VEHICLE—FINANCE WITH US BUY ANOTHER BRAND—FINANCE WITH US

The lower section in TABLE 2 estimates the benefit to a financed party from a $50,000 loan/lease over a 5-year period at Annual Gain of the Company share price of 50% or 100%. The $1,000 grant of Reserved Shares is worth $7,594 at 50% annual growth and $32,000 at 100% annual growth. Should benefits of this nature be experienced by early adopters of the program, powerful viral word-of-mouth comments will be free advertisements to further benefit the program. Also noted in TABLE 2 is the progressively smaller number of Company shares that satisfy a $1,000 incentive award as the unit market share price of the Company increases.

Implementation of this incentive awards program in several market sectors—listed below—is described in detail. A common feature of the chosen sectors is that they involve basically financial activity. This is a non-obvious election that enables in each of them a rapid and relatively low cost gain in market share that is the anticipated singular outcome of this incentive awards program. The proposed methods and systems apply equally well to manufacturing, warehousing, transportation and other market sectors—but the apparatus in these applications would likely be more costly, complex and time consuming.
Residential and Commercial Mortgages
Type 529 Educational Saving Plans
Traditional and Roth IRAs
Credit Cards
Profit Sharing Transactions involving incentive awards (a new market sector)
Lotteries Granting Equity as Prizes (a new market sector)

An additional means of expansion of the program is for the Business Entity to grant Licenses to Operate the present program—for instance, as described below.

Licensing the Present Process

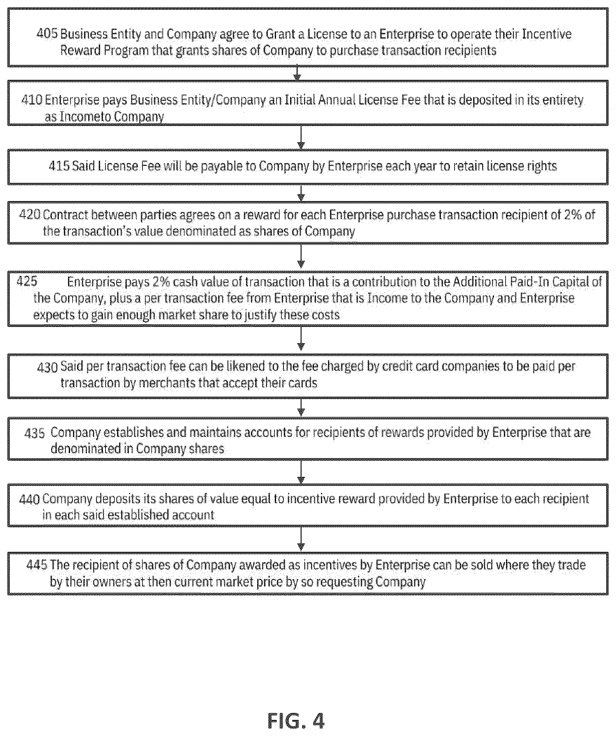

FIG. 4 describes such an alternative move by the Business Entity—granting Licenses to Enterprises to operate the present Incentive Award Program in which shares in the Company are granted to recipients in selected market sectors.

Grants of Licenses can be made to Licensors, herein called Enterprises, in many market sectors, not limited to financial businesses. Both vehicle and home financing markets do not service most Americans who do not incur debt to buy vehicles or premises. Access of the Program to sectors such as fast food, grocery markets, department stores, general stores, gas stations, pharmacies and other lesser cost consumer sectors will be a priority that can be served by granting Licenses.

FIG. 4 describes the Business Entity and the Company of the present invention entering into contracts 405 with at least one licensed Enterprise.

A typical element of said contract 410 is payment by Licensing Enterprise of an Initial lump sum License Fee. It is likely of benefit to the Program if this fee is deposited in its entirety as Income to the Company. Thereby, the unit share price of the wholly owned Company, will increase—to the benefit of all concerned. It is likely 415 that the Licensing Contract will require annual renewal and ongoing payment of an Annual License Fee to the Company to retain license rights.

The Licensing Enterprise's contract 420 will typically involve a payment of, say, 2% of the value of any sales transaction to an award recipient purchaser, said award denominated as shares of the Company. The Company will be paid cash by the Enterprise of value equal to the awarded shares. Said 2% is Additional Paid-In Capital 425 and administration and possibly other fees to the Business Entity and the Company may be involved. Said market sector may be delineated geographically or by other relevant limitation in said contract. The contract may also allow the Enterprise to provide a lesser or greater percentage award in circumstances specified in said Contract.

The Enterprise expects to gain enough market share to justify these costs. Payment for the provided shares is entered by a bookkeeping entry to Company as Additional Paid-In Capital (APIC) and the Transaction Fee is entered as Income. All the Company's APIC, as well as all direct payments of income, are available to the Company to fund expenses and other indebtedness.

While the typically 2% payment of APIC rewards the Company's provision of its shares 430, the transaction fee is akin to the charge made by credit card management companies that is paid by the merchants who made sales to purchasers: The fee facilitates the transaction in both cases.

The Company establishes an account 435 on its website for the Enterprise's rewarded purchasers and records the particulars—namely, the date, the number of shares of the Company, the unit share value, etc. Future purchases by this party will be recorded in this rewarded individual's personal account. All future interaction in this matter—such as requests for sale of shares—will be handled between the Company and the recipient that now owns Company shares. The Enterprise will no longer be involved. The recipient's account may record future purchases from different parties qualified to provide shares of the Company, for instance, in separate pages thereof.

The Company deposits into said newly established account of each Enterprise recipient 440 the reward denominated as its shares equal to the cash value of said reward.

The Company confirms 445 that the Enterprise reward recipients of the Company's shares will have complete access to all transactional records and be able to sell at will shares where they trade. That is, the Company will be the sole record holder and account manager for rewarded transactions conducted by the Business Entity and all Licensed Enterprises that are involved.

An important consideration in offering the present program is that purchasers of goods and services are willing to transfer their business to the party offering incentives—otherwise market share may not be gained. This is a compelling reason to offer incentive awards in financial markets: money is money, a mortgage is funded by money as is a loan.

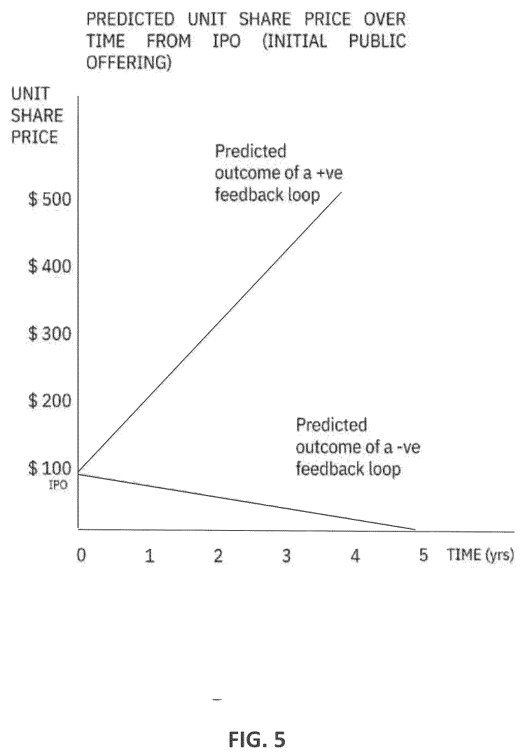

In FIG. 5 a schematic graph illustrates the merit of an enduring pure positive feedback loop, namely, a predicted gain in unit trading share price of the Company that will be the outcome of applying the method of the present patent application—only achievable if the sector of application can involve market share gain. When market share is gained, the cost of providing incentive awards must be less than the profit gain from said increased business. By contrast, a business that consistently fails to operate profitably can enter a negative feedback loop, causes of which can be a declining market sector, a lesser market share or losing money on every sale when costs exceed revenue.

While the US business sector of vehicle financing has great appeal as the focus of launching the present invention it has a limitation: it only spans 10% of the U.S. outstanding debt of retail borrowers. Outstanding auto loan debt in 2020 was $1.3 trillion dollars. Over 80% of new cars are financed. Auto loans are the second most common source of debt. By far the largest indebtedness in the US is for mortgages. Hundreds of companies sell mortgages. Despite the size of the sector, incentive award programs are not offered. Competition is mainly based upon quite small differences in the charged rates of interest.

This sector is clearly a prime choice for the Business Entity to offer shares of the Company as incentive awards. An important plus factor is that the premises themselves are security for a loan—through foreclosure. In this sector, just as in vehicle loans, recipients of incentive awards who default on their debt face loss of a very valuable increase in their restricted shares of the Company in addition to the vehicle repossessed or the premises foreclosed. An obvious further benefit of the mortgage financing market is that substantial gains in market share can be achieved with minimal infrastructure cost. Financing in general is so superior as a sector compared with the costs and time involved in building out requirements for gains in manufacturing markets.

It is possible that the Business Entity already sells mortgages and may elect to first offer the incentives of the present invention in that sector. Also possible is the Business Entity entering the mortgage market sector. Absent such instances, the Business Entity may elect to provide authority, by means of a License, to an established provider of mortgages.

The Process in Additional Market Sectors

The process of the present invention is by no means limited to financial markets—it can be applied in sales of products and services including manufacturing, warehousing, distribution, construction and essentially all business activities. The present focus on financial businesses in this matter is to illustrate how market share can be achieved in cases where infrastructure is readily available, or can be developed speedily, at modest cost. However, expansion can be achieved rapidly when new buildings or machinery or specially trained staff are not required. Accordingly, detailed description of further sectors of application are all financial.

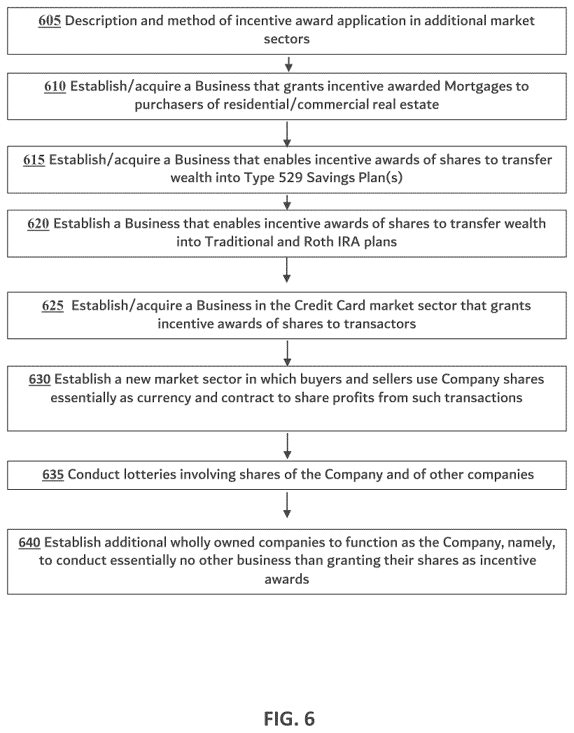

FIG. 6, 605 extends the scope of this invention. Operations of the present incentive award program in the market sectors of mortgages in commercial and residential real estate transactions are described in 610. Residential and commercial mortgages are offered by hundreds of enterprises and account for 70% of US personal indebtedness. Mortgages are usually for 15 or 30 years, they can be of fixed or variable interest rate, they can be original or refinanced, they can require 20% or more or less upfront payment of property purchase cost and can differ in many additional respects. For instance, not all Mortgage Companies grant loans in every US state—there is a significant geographical element in this business sector.

A proposed new sector of business in which the present application is introduced is Type 529 Savings Plans covering tax-saving costs of educational expense, described in 615. It is possible that shares of the Company may not be acceptable as holdings within Type 529 Plans. However, the present incentive award program can have a role in such plans and can be managed for clients by the Company. It is planned that a more aggressive benefit in said Plans will arise from funding them with shares of the Company that have appreciated in value in the accounts of incentive award recipients.

The present incentive award program can have a major role of building wealth in Traditional and Roth IRA plans 620. These U.S. government initiatives are a most important feature of tax-advantaged US savings programs. It is anticipated that incentive awarded shares of the Company equity can provide significant benefit to recipients in planning for retirement. Planned is to fund the IRAs with awarded shares of the Company equity. It is planned that the Company will manage investment strategy for recipients within the present incentive awards program.

The present process enters the everyday, major market of rewarding purchasers of products and services with credit cards 625. Also planned is to make available rewards to the merchants who sell products and services that are charged to credit cards. Additionally, merchants are given the right to vary the percentage of awards rather than accept a fixed rate designated by VISA, Master Card, American Express and other credit card management companies.

A new business sector is described in 630 for buyers and sellers to essentially use shares of the Company as currency. The two parties as debtor and creditor in a transaction agree that the cash cost will be replaced by the debtor providing creditor with shares of the Company having identical value. For example, at $100 transaction cost, debtor will give to creditor restricted shares of the Company of that value (say 5 shares at $20 unit market price). The invented method has particular utility in cases of repeated, identical or similar transactions. For example, payment of monthly rent, mortgages, loans/leases or educational fees. On a mutually agreed specified date in the future buyer and seller will divide any increase in value of shares paid according to prior agreement. The Company will use its methods, systems and apparatus to expedite this program. It is possible that the Company will charge a fee to manage such transactions.

A further new business sector is described, namely, for two types of lotteries 635 to be conducted wherein at least one prize is denominated as shares of the Company. A further possible embodiment is that chances to participate in the lottery may involve prizes as shares of equity in any chosen Enterprise—for instance, a newly established business that wants to advertise its presence. Chances in the lotteries will be sold by the Company that will also manage operating details including selecting winners and paying prizes as shares in its equity and in the Enterprise, where applicable.

After an extended time of operation, potentially in several business sectors, at least one additional or replacement wholly owned Company may be established by at least one additional Business Entity in 640 to establish and operate the methods, systems and apparatus of the present incentive award program. The decision to do so may arise from exceptional volume of the present business leading to better service to participants from making this change, for instance, in ensuring an ongoing adequate supply of shares to be sold to recipients of incentive awards. Or, for any reason at all or for no reason.

Following are sector by sector descriptions of operation in these additional market sectors.

The Mortgage Market Sector

Overview

Granting mortgage loans to purchasers of commercial or residential real estate is a long-established but complex business. Dozens of criteria are involved: length of mortgage 15 or 30 years or custom, amount of down payment, interest Annual Percentage Rate (APR), APR variable or fixed, original or refinance, documentation required or no-doc, accelerated payments or early payoff permitted or not—and many more. The residential mortgage sector encompasses 70% of U.S. household debt. It accordingly appears to be a most desirable sector in which to provide an incentive award program. Mortgage lenders typically seek competitive advantage by offering lower APR or lesser documentation to applicants. Introduction of the incentive award program of the present invention is intended to be a significant factor in market share gain for its operator, the Business Entity or such other party that holds rights to operate this patent in this market sector.

Process and Apparatus

As an example, let us consider one method of operating the incentive awards program of the present invention in the residential mortgage market sector. Table 3 lists the Annual Amortization Schedule of a typical residential mortgage. First-of-all, the amount of the Award must match the substantial scale of the financials involved and the extended time frame.

TABLE 3
MORTGAGE INCENTIVE AWARDS

House Price $375,000
Down Payment: 20% = $75,000
Mortgage $300,000 5.0% FIXED APR 15 YEAR MORTGAGE TERM

TOTAL INCENTIVE AWARD:
1% × $300,000 DENOMINATED AS COMPANY SHARES = $3,000 VALUE
UNIT SHARE TRADING PRICE = $200
THEREFORE, $3,000/$200 = 15 shares granted over the Mortgage Term
INCREASE in TRADING SHARE PRICE ASSUMED = 20% ANNUALLY
SHARES PAID/YEAR = 1

| | UNIT SHARE | | AWARD $ |
|---|---|---|---|
| Year | TRADING PRICE | 20%/YR GAIN | PAID/YEAR END |
| 0 | $200 | | |
| 1 | $240 | 1 × 240 = | $240 |
| 2 | $288 | 1 × 288 = | $288 |
| 3 | $346 | 1 × 346 = | $346 |
| 4 | $415 | 1 × 415 = | $415 |
| 5 | $498 | 1 × 498 = | $498 |
| 6 | $597 | 1 × 597 = | $597 |
| 9 | $717 | 1 × 717 = | $717 |
| 10 | $860 | 1 × 860 = | $860 |
| 11 | $1032 | 1 × 1032 = | $1,032 |
| 12 | $1238 | 1 × 1238 = | $1,238 |
| 13 | $1486 | 1 × 1486 = | $1,486 |
| 14 | $1783 | 1 × 1783 = | $1,783 |
| 15 | $2140 | 1 × 2140 = | $2,140 |
| TOTAL INCENTIVE AWARD | | | $11,640 |

| MONTHLY MORTGAGE PAYMENT: $2,372.38 | |
|---|---|
| 15 YEAR MORTGAGE PAYMENT $427,028.56 | TOTAL INTEREST $127,028.56 |

Selected is an award equal to 1% of the Mortgage Amount, namely 1% of $300,000=$3,000. Listed in Table 3 are the outcome of the award program with the unit trading price of said shares initially being $200. As the program expands it is likely that the trading share price will steadily increase. In the example of Table 3 it is assumed that the trading share price will increase by 20% annually due to the Company having progressively greater Additional Paid-In Capital from selling its awarded shares to a growing number of recipients. As the program expands it is expected that each recipient will purchase more products and services in as many market sectors as they can that award shares of the Company equity as incentives. It is possible that acquirers of said equity will exceed sellers and progressively the share trading price will climb.

The amount of the award in most incentive programs is 2%. This figure has been cited in several of the sectors of application of the present invention. Benefits of 2% awards to recipients have been shown to be substantial over a 5-year loan period of unit share price increase of the shares of the Company. An innovation of the present invention is to provide only a ‘1% reward’ of the amount of the mortgage—but, in a manner that is expected to be appealing to the mortgagee.

A novel method having strong utility through its immediate benefit to the mortgagee is to provide a part of the overall ‘1%’ after only a one year elapse of the 15-year (or 30-year) span of the mortgage. Namely, in the present example by starting at the end of the first-year anniversary of the mortgage signing and annually thereafter by selling one-fifteenth (1 share) of the $3,000 share incentive denominated as shares of the Company. Table 3 demonstrates the potential of a 1% incentive award in the cases of average 20% annual increase from the initial unit share price of the Company. A feature of this method is that the cost to the party operating the program and granting the incentive award is essentially ZERO. As noted in other applications of the present method, the 1% award costs the operator of the program the same amount that the recipient of the payment—its wholly owned Company—gains. The annual partial sale of shares at likely higher price when they were granted does not have any impact on the program operators—the shares are sold on the open market at the then current trading price. Note that the 15 shares purchased by the Business Entity operating the mortgage program each have a unit share trading price of $200 thereby costing $3,000 paid to the Company that gains $3,000 of APIC. One of the shares is released to the mortgagee at all fifteen year ends.

The 20% annual gain yields a valuable overall benefit of $11,642 to the 15-year mortgagee. It is likely that the awards programs of the present invention will generate substantial profit and will command an above average price-to-earnings ratio that bolsters the Company's unit share trading price. The concept of selling shares for the mortgagees exactly yearly on the date the mortgage was signed—rather than, for instance, December 31^{st} for all participants—reduces the impact the annual sales all on one day might have to the stability of market trading.

It is planned that a mortgagee will retain only already paid awards in the event a mortgage is paid off early or ends in a foreclosure.

Unit share price rates of gain that far exceed those cited above have been achieved by many U.S. companies. Notably, A $100 investment in 1965 in McDonald's is in 2022, 57 years late, worth around $1,000,000—operating in a single market sector, fast food restaurants. As a further example, within the vehicle manufacturing and financing sector Tesla until recently surpassed a 50% average annual increase since its IPO in 2004.

Type 529 Savings Account Market Sector

Overview

The state of Michigan originated the tax-advantaged program now known as Type 529 College Savings Accounts over 20 years ago. In 2020 over $360 billion funded such programs in 35 states. U Promise is a credit card issuer that has specialized in making the various programs formulated by many states available to its customers.

An admirable feature of all the programs is that they enable many parties, relatives typically, to put their incentive awards into the account established usually by parents for the benefit of a single prospective student. This feature is present in the incentive award program of the present invention. The Type 529 program has been extended to allow K through 12^{th} grade tuition only expenses to operate federal tax free on capital and gains. A wider range of the costs of higher education, including housing and books, can be disbursed from the accounts tax free. However, most existing Type 529 programs provide investment opportunities that are so conservative that their accumulated value fails to reach the often very high costs of education. Mutual funds and the like are commonplace. This process and apparatus are intended to eliminate this failing.

Following are innovative means that establish a Type 529 savings program that are not available in the prior art. Involved is investment of incentive awards of equity provided by a Business Entity to its customers in a non-Type 529 account that is funded by awarded equity in a Company that conducts essentially no other business than providing awards of equity in its own financial performance, establishing and managing general accounts for each of its awarded recipients, accepting revenue from all sources including from said Business Entity and of all types including without limit fees and licenses, and productively investing the numerous contributions to said Company's Additional Paid-In Capital arising from sales of its equity.

It is anticipated that a novel, high utility program which combines initial investment in a non-Type 529 account followed by transfer of accumulated funds into a Type 529 account, will be available to all U.S. residents. Said Company is wholly owned by said Business Entity. Said Business Entity's customers are granted incentive awards denominated in said Company's equity, for instance shares of common stock that may be sold where they trade by incentive recipients

The program of the present method provides rewards in an entity whose unit share price is dependent solely on its own financial performance. Thereby, operating profitably, the more parties transacting with it the more its unit share price increases thereby attracting even more transacting parties resulting in a positive feedback loop that can scale indefinitely.

A feature of Type 529 accounts is that funds in them can be disbursed to pay educational expenses without having been required to reside in said accounts for a specific length of time. The method of the present invention is to combine a first period of exceptional increase of the value of funds with a short, following period-of-time during which it may well achieve lesser gain in an actual Type 529 account. Accordingly, planned are methods to provide substantial returns in investment together with tax-free disbursement. The method of the present invention involves a sequence of procedures.

Firstly, a party of at least one person, typically an individual or a married couple, makes purchases from a Business Entity that provides incentive awards denominated as equity in its wholly owned Company. As their purchases accumulate and their awarded equity, for instance shares of stock in said Company increases in value, said awarded customers accumulate wealth in their general account. The account remains denominated in shares of equity.

Secondly, said party selects a Type 529 College Savings Fund from the very large number of such plans that are available in the US. Said party declares that the worth of said fund will be disbursed at some future time to a person they name, typically a prospective student who is a child or grandchild or other relation of said party. Said party repeats this second step for each person it elects to benefit from a Type 529 program. While this step can be taken when the prospective beneficiaries are young it need only have been completed when deposits converted to cash are ready to be made.

Thirdly, said party will allow said at least one non-Type 529 account denominated in said shares of equity to so remain and will add further funds so denominated, typically from time to time. No regulations apply during this quite often lengthy period. Most benefit will likely occur by leaving all deposits denominated as shares until they are sold and the cash proceeds will be deposited in Type 529 accounts for essentially immediate withdrawal thereafter.

Fourthly, at such time as expense of education becomes payable for said student the party will disburse cash accordingly from the applicable Type 529 account. A condition of a Type 529 account is that a disbursement in a given calendar year must be actually expended in the same calendar year for allowed educational expenses in order for the sum so expended to be free of tax.

A valuable feature of this stated method is that the funds of said party are initially invested and grow in value without having to conform to the regulations that limit Type 529 accounts to the provision of conservative investments. It is possible that the nominal risk/reward nature of most shares of equity of a single company, as of the Company in the present method, would not qualify as allowed investments actually within any Type 529 plan.

In the present invention there is a wholly owned Company that disburses awards of its equity to incentivized recipients. In addition to amassing considerable Additional Paid-In Capital thereby, the Company receives revenue from the Business Entity that owns it. Further revenue will be generated from productively investing its ever-increasing capital, for instance, in tax-free government bonds.

A notable benefit to incentive awarded parties with accounts managed by the Company is that Company Apps include assistance and guidance in managing the outlined procedures listed above.

The company selling its shares in return for payments that contribute to its Additional Paid-In Capital is a bona fide business activity. Clear evidence in this regard is the fact that the equity of the Company will be traded on a stock exchange or privately, will follow generally accepted accounting methods and will issue financial statements regularly in conformity with all applicable regulations. The Company's activity will be completely transparent and full details will be accessible to all.

IRAs with Incentive Awarded Equity

Overview

Available in the U.S. are two distinct tax-advantaged Investment Retirement Accounts (IRAs). Both types of account are held by individuals, both require funding with currently earned income and both have annual limits of investment. A Traditional IRA Account is funded with pre-tax money whereas a Roth IRA is funded with tax-paid resources. Useful strategies are to fund a Traditional IRA in a year to the maximum allowed in a high-income year thereby postponing tax due until making a withdrawal when a lower tax bracket applies (for instance, typically after retirement). A good strategy in funding a Roth IRA is to pay in funds on which modest tax rates have been paid. It is therefore useful for teenagers with earned income to establish a Roth IRA and fund it as much as possible, after tax, but often with no or low tax having been paid. Then to continue funding the Roth IRA as fully as possible while tax rates are low. A disadvantage is that at a young age earnings will likely also be low so it is difficult to fund annually to the maximum allowed. Published data indicate that over 500,000 individuals in 2011 had Roth IRAs worth over $1 million. A person who contributed the maximum annually (originally $5,500 later raised to $6,500 a year) from age 18 until age 70 with annual gain of 7% would have a Roth IRA worth over $2.5 million. The major merit of the program is that the earnings as well as the invested capital are withdrawn tax free.

A further significant advantage of the Roth IRA is that virtually no regulations dictate how withdrawals are made except for penalties for early withdrawal. Another advantage is that contributions can continue to be made while income (W-2 or 1099) is still being earned. A Traditional IRA is more closely regulated. Withdrawals must be made annually after a retirement age is reached and no deposits can be made after this. As of 2022 a first Required Minimum Annual Distribution is for the year in which a person reaches age 72 years and tax must be paid on withdrawals annually with income tax return due in mid-April of the following year.

Process and Apparatus

The present application is original and of substantial utility compared with the prior art. The present method of establishing an incentive awards program improves upon the prior art established in issued U.S. Pat. No. 7,219,071 by having the Company issuing shares of its equity being wholly owned by a Business Entity. Further, the general account of each recipient in which said equity is initially denominated as shares can transfer funding as shares into Traditional and Roth IRA accounts. In this regard, said Company granting said shares of equity provides an IRA APP that enables said shares from said general accounts to be deposited, still denominated as equity, in said IRA accounts. The APP, developed and managed by the Company will monitor deposits to ensure that the annual limit on overall deposits is not violated. Holders of IRA accounts will be able to access the status thereof by searching the dropdown Main Menu for the appropriate Company APP. In the event that shares are not available with sufficient worth to fully fund their account, the Company will allow cash deposits of earned income to be deposited. Said APP provides additional utility in later monetizing said equity, both automatically as appropriate and as required by federal regulations, and also as otherwise specifically requested by said account holders.

Credit Card Incentive Awarded Market Sector

Overview

The modern history of incentive awarded transactions began in earnest with frequent flyer miles introduced in the 1970s. Diner's Club really expanded the market sector in 1981 by providing incentive awards on credit cards—denominated as miles.

The present-day incentive awards market is largely for cash-back programs that reward credit card transactors with a percentage of the cash value of a transaction. Some rewards are a fixed percentage on every transaction, often one to two percent. Others provide different reward percentages for different categories of purchases such as groceries, restaurant meals, airfares, hotels and so on.

The rewards market has changed little in a decade. For instance, no credit card provider has sought to gain market share by providing even a very small interest APR on the accumulating cash value of awards in clients' rewards accounts. Accordingly, the relatively uniform provision of similar reward programs has not led to major market share gains by any of the provider.

There are literally thousands of issuers of U.S. credit cards. Banks, notably Bank of America and Capital One, have substantial business in the sector in addition to their other financial activities while American Express is unique in conducting essentially no other business. The business is profitable despite customer defaults being rather significant. The high rates of interest, typically over 15% APR charged to customers on outstanding balances that in the U.S. average over $5,000 per account, are a major source of income to issuers of cards. It is notable that over 70% of the U.S. credit card market management business is controlled by Visa and Mastercard.

Historically, MBNA bank managed to own over 15% of the U.S. credit card market by employing an incentive award program. Their method: purchase personal data, particularly phone numbers, for instance of all the alums from colleges, and employ thousands of staff to phone these prospects. MBNA paid very little for this information. The reward to clients cost essentially nothing: provision of a credit card emblazoned with the logo/crest of the entity with which the new card holder identified. This business was eventually sold for over 20 billion dollars. So, the credit card market has experienced the outcome of a very popular incentive method. It is notable that this success was achieved by a bank.

Process and Apparatus

The business claimed in the present patent application is expected to be successful in gaining market share for the parties that provide its powerful incentive awards. It is anticipated that millions of early adopters will replace the thousands of MBNA's phoners with word-of-mouth free advertising to encourage others to participate in the program. Notable in the system of the present invention is that shares already awarded to recipients increase in value as subsequent profitable business increases the unit trading share value of the Company's equity. Early-adopters profit by encouraging friends, family members and even total strangers to enter the program.

The credit card market is seen as being important in broadening access for the present program to include a diverse range of participants making lower cost purchases, for instance, buyers of groceries, fast food meals and many other products and services of smaller value.

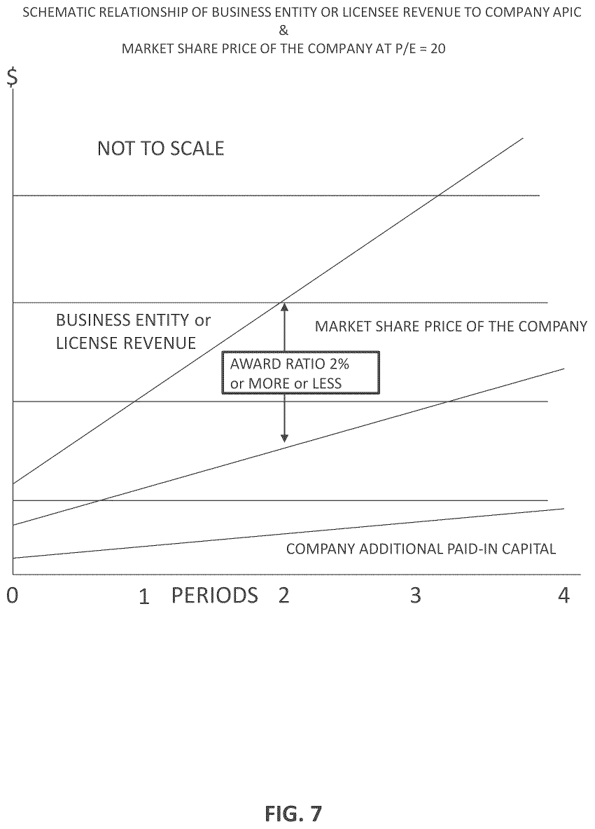

FIG. 7 illustrates the apparatus and novel methods that are of considerable utility in implementing the planned credit card business operations. Every merchant that accepts the incentive award credit cards of the present invention displays this fact on a bold notice at the entrance to the premises 705. A key element of the system is that prospective participants in the awards method can apply for a credit card with any merchant and have their card issued within 5 minutes if they qualify. The application procedure requires the merchant to process personal data of the applicant which is transmitted to the Company by means of encrypted messaging. Each merchant is provided with three sophisticated devices that have been designed to enable speedy and secure issuance of credit cards: An APPLYING DEVICE into which personal data and security information is entered, a CUSTOM PRINTING DEVICE that prints and etches the said information on a newly issued card and a CARD READING DEVICE that enables transactions to be processed when purchases are made.

Referring to FIG. 7, every merchant uses its Applying Device to process applicant's request 710 for a credit card. The applicant shows a photo ID and enters a personal password 715 that must be announced if requested when later making a purchase. Standard personal data are entered into the device 720 plus unique security elements, namely a facial image and a fingerprint. By pushing a button on the device, the merchant transmits all the data 725 to the Company using encrypted communication means. The merchant inserts a blank credit card into Custom Printing Device 730 in readiness for the Company approving the application 735. The Company notifies the merchant that the account 745 is approved and triggers the inscription 750. The data of the application is processed automatically at the Company through use of a custom designed computer application. The facial image and fingerprint are incorporated in the security system of each issued card 740 and the transaction procedure in any Card Reading Device 755 requires a purchaser's image to match that lodged in the card when it is read 760. For the cardholder to allow another person to purchase with the card, the password must be provided to this other party 765 because the security measures will otherwise block the transaction.

The Company maintains records of recipients' balances in a personal account that has been. established for each individual, both the wealth denominated as shares and the amount of cash. An App on the Company's website enables an account holder to sell some or all of the holding denominated as shares on the site where the shares are traded. Said App requires the seller to enter the personal password that was provided 710 when the account was established. Said App additionally enables the recipient to withdraw shares and cash from the account. The App enables withdrawals to be transferred to the account of another recipient within the Company system or to any outside account that can be reached securely online.

Access to the credit card market, in the U.S. and worldwide, can be made by penetration at a number of different levels in the credit card business. For instance, at its highest level—by competing with American Express, Visa and Mastercard through establishment of a new, multi-billion dollar back-office Management Organization, called perhaps SHARES with this name on credit cards. Or by licensing exclusive rights to one of the existing multi-billion dollar back-office enterprises. Or by starting or acquiring a financing organization, such as a bank re-named perhaps SHARES, that will simply issue credit cards providing incentive awards of the present invention. Or by licensing the method to a major, national credit card issuing company. Alternatively, smaller, regional banks could each be granted licenses whereby they will expect to gain market share, perhaps only locally.

Whichever point of entry is chosen it is probable that the credit card market will be disrupted by the introduction of awards denominated as equity. A possible reaction is that existing companies in the credit card business will offer their own shares as rewards or provide some other form of risk/reward investments. It is anticipated that the Company and its owner will negotiate with existing entities in the credit card sector to protect as much as possible the present infrastructure without compromising its own entry. Particular care will be taken in the preparation of contracts to eliminate the risk of an acquirer of rights making efforts to suppress the present program with a pocket veto!

Several changes in the methods, systems and apparatus of operation of the credit card business, each original and of considerable utility, are claimed in this patent application. For example, in Table 4, by allowing merchants, indeed all acceptors of credit cards of the present invention, to vary the percentage of shares of the Company that they grant to purchasers, from day-to-day or in any way they wish. Other changes, without limit, could be made for a sales event or to encourage sales of a slow-moving product or a brand name of merchandise.

Recipients of awards will have access at all times to the comprehensive records maintained by a Company App in their individual accounts. The history of every transaction will be available indefinitely. Additionally, a monthly Statement will summarize the most recent activity such as awards, transfers of shares to other accounts, sales of shares and so on. In this respect it will be similar to the monthly invoice provided to credit card users. Additionally, recipients will be pleased to see in considerable detail the awards they have received denominated as shares of equity in the Company.

A very satisfying feature for the recipient of the STATEMENT is seeing that shares awarded before the current billing period are ‘marked-to-market’ providing more wealth if the unit share price has increased. Note that the accounting method illustrated uses an unchanging unit share price throughout each billing period. This is simpler, and would be surely less costly, than calculating awards based on the actual share price, say, at close of business, on each transaction day. Details of this nature will be decided once the program is operational. Participants would probably be more satisfied with a daily, or even minute-by-minute, update of the value of their account.

Table 4 is an example of a monthly Statement. It is likely that merchants will be enabled to post notice of special grants of higher percentage awards that they will offer in the upcoming month

TABLE 4
MONTHLY STATEMENT FOR CREDIT CARD CUSTOMER
CARD NUMBER: 012345 TOTAL SHARES IN ACCOUNT on Nov. 17, 2022: 3.640

| | | |
|---|---|---|
| Nov. 18-Dec. 17, 2022 | Unit Market Share Price on Nov. 17, 2022: | $10.00 |
| | Account Value on Nov. 17, 2022: | $36.40 |

Company declares Unit Market Share Price from 11/18-12/17 to be $11.40
Note: To simplify the Table share price fixed at $11.40 from Nov. 18, 2022 toDec. 17, 2022

TRANSACTIONS

| | | | | Reward* | Cash | Shares Awarded |
|---|---|---|---|---|---|---|
| | | Ref. | Amount | $ | Value | to Account |
| Date | Description | # | % | (NOT TAKEN) | | (ACCEPTED) |
| 11/19 | Sang Lee Bistro | 9672 | 28.62 | 2.0 | $0.57 | 0.050 |
| 11/22 | Nicholas Spa & Salon | 0177 | 75.00 | 2.0 | $1.50 | 0.132 |
| 11/29 | Deville Gas | 0439 | 37.00 | 3.0 | $1.11 | 0.097 |
| 12/02 | CRS Pharmacy | 8536 | 27.73 | 2.0 | $0.55 | 0.049 |
| 12/09 | Aux Francais Delices | 0229 | 55.65 | 4.0 | $2.23 | 0.195 |
| 12/12 | Creole Foods 10053 | 1317 | 126.97 | 3.5 | $4.44 | 0.390 |
| 12/16 | Gentle Wine & Spirits | 4830 | 82.51 | 2.0 | $1.65 | 0.148 |
| 12/17 | Nordstoll | 077 | 480.00 | 10.0 | $48.00 | 4.211 |

| | | |
|---|---|---|
| TOTALS: | $913.48 | 5.272 |

*NOTE: A MAJOR patentable feature of the PROGRAM - credit card acceptors provide whatever %
REWARD they wish. Their fee will change accordingly. MAKES FOR INTERESTING COMPETITION!

| | |
|---|---|
| Previous Balance of owned SHARES on 11/17: | 3.640 shares |
| NEW VALUE of these SHARES on 12/17: | 3.640 shares × $11.40 per share $41.496 |
| NEW REWARDS earned from November18: | 5.272 shares × $11.40 per share |
| $60.101MARKET VALUE OF ALL SHARES as of Dec. 17, 2022 | $101.597 |
| OWNED SHARES of the COMPANY, Dec. 17, 2022: 3.640 + 5.272. | 8.912 shares |

BALANCE DUE $913.48 DUE DATE: JAN. 10, 2023
Pay Balance Due into Your Account by Wire Transfer On or Before Due Date

Several provisions in the present invention considerably advance the prior state of the art. In addition to the freedom for all acceptors of credit cards to have a say in the percentage of awards paid to customers, as shown above, further advances are introduced and summarized below:
Allowing merchants, and indeed all acceptors of credit cards, to receive rewards of shares in the Company on transactions with purchasers if they so wish.
Allowing the above acceptors to change the awarded percentage of said shares that they grant from time to time for whatever reason they choose.
All grants of shares will involve payment of fees tailored to the awarded percentage thereof, generally a fee of the same value as the incentive award.
All of the above provisions will be managed and recorded in the accounts established for all parties by the Company. Accounts will necessarily be established by the Company for all parties receiving awards of its shares.

The above provisions are recognition of the important role played by merchants and all acceptors of credit cards in transactions. In present day practice merchants pay fees to the credit card provider and have no opportunity to benefit financially from the credit card element of transactions. It is possible that said provisions will encourage merchants to accept only credit cards that provide awards of shares of the Company. Notable, also, is that the novel provisions listed are likely to increase the number of the Company's shares involved in many transactions, thereby enhancing the per transaction inflow of Additional Paid-In Capital.

Profit Sharing Transactions Involving Shares

Overview

Known in the prior art is the method of providing payment of a bill by a billed party wherein said payment is denominated as shares in said party's equity ‘when-issued’. The method is commonly used by cash-short companies prior to being publicly traded. Creditors accept this provision of equity in place of cash in expectation of said equity possibly increasing in value. Note that the party providing its equity does not benefit if the specific transferred shares increase in value in the hands of the creditor. Said method of paying bills with when-issued equity is regulated, namely the cumulative disbursement of equity is limited to a certain maximum amount. Google is an example of a company that paid bills with when-issued equity that exceeded this limit and came close to having its Initial Public Offering denied.

Process and Apparatus

Prior art is limited to ‘once and done’ payments, as in the payment of a specific invoiced bill, without the profit-sharing elements of the present patent application. Substantial utility accrues in the method of the present invention in that the paying party shares in any gain of the value of equity that is provided as payment. The method comprises being used to pay for services rendered wherein an identical payment is made repeatedly, for instance, monthly. Examples include, without limitation: Rentals, auto leases and loans, mortgage monthly payments and fees for educational terms or semesters.

It is possible that creditors willing to accept payments denominated as shares will thereby attract more business as a very favorable outcome. Users of this new method in the present invention are billed parties that have been granted shares of equity in the Company that provides its equity to parties who are awarded said shares of equity as incentives. The requirement that both the debtor and the creditor hold personal accounts at the Company greatly facilitates the present transactions that can then be enabled by at least one App developed and operated by said Company. In addition to transfers of shares of equity, the subsequent profit-sharing elements of the method are expedited thus making this method effortless for all involved. Possible benefits to the Company are to charge a fee for managing the procedure or by requiring payment of a portion of the gain from profitable transactions.

Suitable computerized apparatus will accept specific elements of the method, for instance: cash amount of payment, number of shares of the Company at their current market trading price that are needed to be substituted for cash, the identity of the paying and the receiving parties, the date on which the division of gained profit will be made and the per share market trading value of the Company's equity on that date. It is conceived that a number of different contract terms whereby profit will be divided will be offered within said computer App and both parties will agree to use one of them. Upon the terms of the division of profit being agreed, the Company will transfer shares of restricted equity between the involved parties in lieu of cash. The restriction will be lifted upon the arrival of the date when the amount of the debt will be paid and any profit divided. It is probable that the entire process will take place automatically once the parties thereto launch the transaction after specifying the necessary options on the computer App provided by the Company.

In the present invention there is a wholly owned Company that disburses awards of its equity to incentivized recipients. Said Company conducts essentially no other business than providing said awards of its equity to said customers, establishing and managing their rewarded accounts, accepting revenue from all sources including from said business entity and of all types including without limit fees and licenses, and productively investing the numerous contributions to capital arising from sales of its equity. The Technical Operations function established by the Business Entity will innovate the apparatus that will enable the system of paying bills with its shares between parties holding personal accounts established and managed by the Company.

Its granting of shares as rewards does not lead to any dilution to the value of existing issued shares—because these newly granted shares are sold at their prevailing market value. In addition to amassing considerable Additional Paid-in Capital (APIC) thereby, the Company receives revenue from the Business Entity that owns it and from other parties to transactions. Further revenue will be generated from productively investing its ever-increasing APIC, for instance, in short-term tax-free government bond held to maturity

The Company selling its shares in return for payments that contribute to its APIC is a bona fide business activity. Clear evidence in this regard are the facts that the Company will be publicly traded, will follow generally accepted accounting principles and will issue financial statements regularly in conformity with all applicable regulations. Full details of the Company's activity will be transparent and accessible to all.

Lotteries with Shares as Prizes

Overview

Lotteries are regulated by states and the federal government in the U.S. Said regulated lotteries can require a winner to predict the numbers drawn as the stated winning numbers by the party operating the lottery and the at least one prize is very often cash. Various lottery-like enterprises do operate without running afoul of regulation. It is commonplace for lottery tickets to be sold at private events, comprising in support of charities, wherein the main or only prize is a valuable object rather than cash prizes being awarded and winners are participants holding tickets that match ticket numbers drawn by chance by the operator of the lottery. Most casinos have slot machines that deliver a very large cash prize infrequently. The method is progressive in that each single time the machine is played a small increase in the eventual prize is registered. Power Ball is a lottery played in 45 states and other jurisdictions three times weekly. Numerous online sites and stores enable purchase of Power Ball entries costing $2.50 and a progressive main prize can be as much as tens of millions of dollars. Bingo is a type of lottery. It too is regulated by Federal, state and local jurisdictions. A typical game costs $2.50 to play for a prize of up to a few tens of dollars—depending on the number of players.

Process and Apparatus

Two different processes of the present invention are envisaged. A Type 1 lottery involves only the Business Entity, the Company and parties buying chances to win at least one prize provided as equity in the financial performance of the Business Entity's wholly owned Company.

A Type 2 lottery additionally involves an Enterprise offering prizes denominated in its own shares as well as prizes of shares in the Company being awarded. In this second method the lottery can be named for the Enterprise seeking exposure. A method of a Type 2 lottery system is that Business Entity, Enterprise and Company participate and chances are marked as Company or Enterprise and prizes, denominated as round numbers of dollars, are awarded as the equivalent value of either equity in the Company to parties holding Company chances or equity in the Enterprise to parties holding Enterprise chances. Prizes denominated as shares of equity in the Enterprise are deposited in winners' Lottery Accounts provided by the Company denominated as shares of the Enterprise with cash value equal to the prize. These prizes of Enterprise equity can be transferred as Enterprise equity from said accounts to outside accounts possessed by said winners or they can be sold where they trade from the Company account and the cash proceeds can be retained by said Enterprise winners in said Company accounts.

A benefit to the Enterprise is that the shares of the Company are of proven worth. The Enterprise expects to gain valuable publicity and prestige by means of association. Said Enterprise might be a newly launched company that seeks to become more widely known. Said enterprise could be a company that needs to raise capital by arousing interest in itself. A requirement is that all purchasers of chances, both for Company prizes and for Enterprise prizes have a general account developed by and operated by said Company. This requirement enables the apparatus and system of the Lottery App on the Company's website to operate Type 1 and Type 2 lotteries cost effectively through record keeping and activity being essentially automatic.

A business method of the present inventions is envisaged as a periodic lottery that sells a stated number of chances, or an unlimited number, as the Business Entity and any participating Enterprise may choose and agree. The Company will develop and operate an App to conduct its effort in a lottery. In a method of a Type 1 lottery solely involving the Business Entity and the Company, chances to participate will be priced at a set cash value, say $5.00. Holders of accounts provided by the Company will access the App that accepts participation and essentially operates automatically once the registrant enters data. Chances to participate, while priced as a cash round number, will require purchase to be by shares that are in the registrant's general account. Likewise, prizes will be credited to said accounts denominated as shares even though their value is listed in round figure amounts of cash. This method seeks to eliminate difficulty in delivering the exact correct prize when the unit market share price of Company equity can vary minute to minute. The method comprises a round number of prize money deposited to winner's general account as shares calculated to match the cash prize at the unit market value share price at the end of trading on the day the list of prizewinners is announced.

The Company's participation in said lotteries qualifies within its ‘conducting essentially no other business than providing its shares as awards and managing accounts of recipients’. The methods, systems and apparatus of the Lottery embodiment of the present awards program do not involve risk/reward business activity beyond its stated activity within the limits of the present invention.

One example of the method of operating a Type 2 lottery that includes an Enterprise as well as the Business Entity, the Company, shares of the Company, shares of the Enterprise and purchasers of chances is as follows:
Terms of the lottery are announced—prizes will be awarded as round figure cash amounts denominated either as shares of the Company or shares of Enterprise: for instance, GRAND PRIZE OF $10,000 in COMPANY SHARES or GRAND PRIZE OF $10,000 in ENTERPRISE SHARES.
Chances priced at $5 to win prizes of Company shares will be marked Company and $5 chances to win Enterprise shares will be marked Enterprise while $10 chances can win prizes of shares in both Company and Enterprise and be so marked.
Prizes to be denominated as shares of the Company will be deposited in winners' Lottery Accounts provided by the Company as shares with cash value equal to the prize.
Prizes denominated as shares of Enterprise are likewise deposited in winners' Lottery Accounts provided by the Company denominated as shares of the Enterprise with cash value equal to the prize.
Enterprise shares in said accounts provided by the Company can be transferred as Enterprise equity from said accounts to an outside account possessed by said winners—or, they can be sold on the open market and retained in the Company account as cash proceeds therefrom.
While shares of Enterprise are initially deposited in the Company account they cannot remain there as such—they must be transferred out or monetized to remain as cash in the Company account.
Both the Company and the Enterprise will receive Additional Paid-In Capital from sales of their respective chances in the respective unit market value of the shares awarded multiplied by the number thereof. Money not listed above is the operating profit of the Business Entity. It is likely that the Business Entity and the Company will conduct lotteries on a regular basis or simply from time to time with or without at least one other Enterprise promoter involved.

The above examples comprise, without limit, the operation of the present method. A requirement of this lottery business is that the Business Entity and the Company are provided with the necessary communication and computer electronics systems and apparatus custom designed and installed, free of cost to the Company, by the Technical Operations function established and funded by the Business Entity. It will comprise automated software that processes the described business activity.

List of Company Apps for all Market Sectors

Table 5 is a dropdown menu of sites that the Technical Operations function will develop for the Business Entity and the Company that will provide comprehensive services for recipients of shares of the Company's equity who have their own personal financial accounts. Each recipient has a general account and may request and receive services involving additional specialty accounts as listed below.

TABLE 5
MENU FOR RECIPIENTS' PERSONAL
ACCOUNTS ON COMPANY WEBSITE

```
Numerous Apps are available to Account Holders to process the multiple
embodiments of the present patent.
Press MAIN MENU to access.
Enter User Name_{——}_{——}
Enter Password/Passkey_{——}_{——}
  View current general account status.
  Enter order to sell shares.
  Transfer shares to another Company account holder.
  Check status of your mortgage.
  Check status of your auto financing.
  Check status of your Traditional IRA Account.
  Check status of your Roth IRA Account.
  Make deposits or withdrawals in IRA Accounts.
  Withdraw cash from your general account.
  Pay a bill with shares.
  Set up conditions and process of paying a debt with shared profits.
  Access your Type 529 Accounts.
  Make transfers from general to IRA account.
  Review procedures of available lotteries, purchase chances & receive
  prizes.
  Transfer cash or shares to a charity of your choice.
  Print calendar year transactions.
  Print month by month credit card transactions.
  Pay credit card invoice with cash or shares.
  Transfer pages from your account to your computer.
  Print pages.
  OTHER: Select help from options or enter SEARCH.
```

Technical Elements of the Process

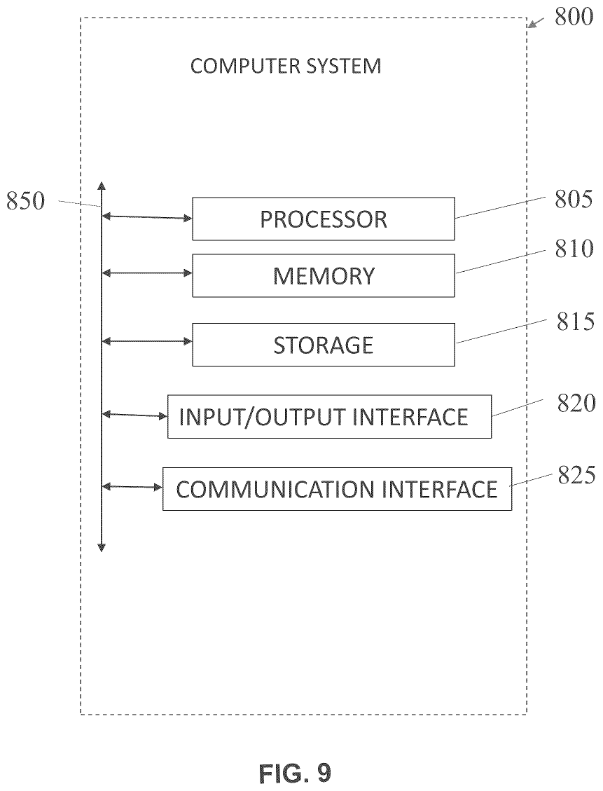

FIG. 9 illustrates a computer system, 800. The components may have hardware and software in common while having diverse uses. One or more computer systems 800 will perform at least one step of described methods. Software running on at least one computer system can perform multiple functions. The Technical Operations function established, funded, staffed and operated by said Business Entity of the present invention will acquire and develop the exceptionally broad range of communications and computer electronics apparatus involved in said far reaching activities. It is probable that the present business methods and systems will require apparatus that will embody many patentable elements. The range of services offered to recipients of awarded shares of equity will benefit from Artificial Intelligence innovations that provide excellent advice that is easily accessible. Once first-class technology is in place, the Business Entity and the Company will benefit from cutting edge cost effectiveness. The technology that will be developed will strengthen the Intellectual Property of this innovative incentive awards program. The early-stage computer system 800 will take any suitable physical form. For instance, computer system 100 may be embedded, a system-on-chip, a single-board computer system, a desktop computer, a laptop, a mainframe, a mesh of systems, a cell phone, a server, an augmented/virtual reality device or a combination of at least two of the above. Computer system 800 may include more than one system 800, be unitary or distributed, and may occupy multiple locations including multiple data centers. Computer systems 800 may reside in a cloud and may have more than one cloud components in one or more networks. Computer systems 800 are able to perform one or more steps described herein in real time or batch mode.

In particular embodiments computer system 800 will a processor 805, memory 810, storage 815, an input/output interface 820, a communication interface 825 and overall, a bus 850. While a specific array of components is described in this disclosure, contemplated is any at least equally functional computer system comprising any array of suitable components and methods. Embodiments will require hardware in system 800 to execute instructions. For instance, processor 805 may take in instructions from an internal register or cache, or from memory 810 or storage 815—for execution by one or more of the processors 805 in the system that are suitable. A processor 805 may deliver outcomes to storage using one or more memory buses or to one or more processors 805 for further action. In selected embodiments, memory 810 includes random access memory, either single- or multi-ported. Some embodiments will require Memory Management Units to enable transfers of data.

Storage 815 will include one or more hard disk drives, floppy disk drives, flash memory, magnetic tape and either a combination of two or more of these or a Universal Serial Bus drive. Embodiments will include memory that is internal or external to the computer system 800 and, in some embodiments, will be non-volatile, solid-state memory (read-only where appropriate). Any suitable storage system may include storage control units.

The present process is designed to gain market share in almost all business sectors, but the applications cited have been selected to enable substantial penetration at minimal cost and passage of time, by focusing on financial sectors so as to minimize expansion of bricks and mortar infrastructure, thereby providing business success without the need for major innovation of apparatus yet the Technical Operations function will develop as much cutting-edge apparatus innovation as will be required, particularly in communication and computer-electronics.

The input/output devices and interfaces include hardware and software involved in many of the transfers of data throughout the computer system 800. Input/output devices and interfaces 820 are manifold including those illustrated in FIG. 5. Hardware throughout the computer system 800 may include scanners, touch screens, keyboards and mouses, monitors, copiers, printers, data retrieval systems and numerous custom-designed devices. Many operations will involve Wi-Fi networks and numerous Internet connections. Wireless transmissions will be prominent in virtually all embodiments throughout this disclosure. The bus 830 will function prominently throughout embodiments. The technology may include an Accelerated Graphics Port, a HYPERTRANSPORT Interconnect, a Peripheral Component Interconnect bus and other suitable buses including combinations thereof.

Described above are many of the technologies that will be embodied in the functioning of this major-scale enterprise. The scope of the present disclosure will involve considerable customization of much of the software and hardware that will be needed. It is anticipated that Artificial Intelligence will find many applications, particularly in client-to-management (and vice versa) interaction leading to greater efficiency, more accurate and speedier customer service and substantial cost savings. The program will also benefit from methods, systems and apparatus that minimize the operating costs of the Company: thereby, its profitability will be enhanced and recipients of its shares can expect faster sustained increase in the Company's trading share price.

Having thus described the invention and various of its aspects, the subject matter I desire to claim and hereby protect by Letters Patent, is recited in the following several:

1: A process by which a Business Entity implements at least one incentive awards program, capable of providing an enduring pure positive feedback loop, comprising the following steps:
a. the Business Entity records sales to customers that elect to participate in the incentive awards program and
b. the Business Entity grants incentive awards corresponding to said sales to said recipients, wherein said recipients are granted said incentive awards in an awards program provided by the Business Entity via a wholly-owned Company, said incentive awards being denominated as shares of equity in said Company, wherein said Company conducts essentially no other business than providing said incentive awards, whereby the aggregate value of said incentive awards is solely determined by the financial performance of said Company,
c. said Company operates profitably, funded by receipt of Additional Paid-In Capital equal to the trading value of its shares that have been granted as incentive awards, and additionally, from remittances to said Company by parties that include said Business Entity and others that benefit from providing said incentive awards, and
d. the Business Entity ensures profitable operation in said program by said Company, the Business Entity being in control of said Company's operational expenses and income from all sources, and the unit share trading price of said Company increases based on the profitability of said Company, and
e. the Business Entity periodically reports to said recipients participating in the incentive awards program the unit share trading price of said shares of equity in said Company, and
f. the ongoing increase in the unit share trading price leads to additional participation in said awards program, due to the reporting of more profit and concomitant higher unit price of shares of equity in said Company and thereby leads more recipients to enroll in the program and thereby produces more profit leading to the pure positive feedback loop of the present invention, and
g. said Company continues to issue shares as incentive awards, said shares increasing in value based on the profitable incentive awards program in which its shares are denominated as awards, and
h. said recipients of said incentive awards are afforded the opportunity to sell the Company shares that they own where they trade, thereby benefiting from unit share price increase arising from ongoing profitable operations of said incentive awards program.

2: The process of claim 1 wherein the Business Entity provides incentive awards to recipients financing the outright purchase of vehicles, the purchase of vehicles by means of leases and/or loans and said awarded shares are sold by recipients when the balance of any debt is zero and wherein default of financing payments leads to loss by customer of all awarded incentive shares as well as repossession of the vehicle.

3: The process of claim 2 wherein said Business Entity providing awards manufactures and finances said vehicles and, additionally, said Business Entity finances leases or loans to purchasers of vehicles manufactured by others, wherein incentive awards are provided only on the amount of said financing.

4: The process of claim 1 wherein the percentage of the incentive award relative to the sale value of any product or service may be set and may be changed by the Business Entity at any time and for any reason and for any duration including to bolster profitability or to encourage purchase of a particular product or service.

5: The process of claim 1 wherein the Business Entity provides incentive awards to recipients financing respectively residential or commercial mortgages according to mutually agreed terms of contract and the incentive award is a number of shares based on elements of the contract including, without limit: the Company share price; the loan amount; the annual rate of interest, fixed or variable; the credit rating of the mortgagee; the desirability of the subject property; and the time span of 15 years or 30 years or other mutually agreed upon period.

6: The process of claim 5 wherein the total number of shares of the incentive award is listed in the mortgage contract and terms of payment are set, typically: one-fifteenth of the agreed upon number of shares sold annually for a 15 year mortgage term and one-thirtieth of the awarded shares sold annually for a 30 year contract, in each case at the unit trading share price of equity in the Company that prevails at each sale and the cash proceeds are paid to the mortgagee, whereby the awards recipient receives the benefit of cash payments annually as well as increasingly larger rewards as the trading unit share value of Company equity increases year to year.

7: The process of claim 5 wherein foreclosure on the loan leads to loss to the mortgagee of yet unsold shares and, similarly, prepayment of the loan results in forfeit of the shares that have not been sold and retention by the mortgagee of the cash proceeds from shares that have been sold.

8: The process of claim 1 wherein a recipient of incentive awarded shares of the Company, hereinafter an “establisher,” determines to establish a Type 529 Savings Account for each selected student, such as a son, daughter or related child, and registers said Type 529 Accounts on said recipient's personal account that is provided by the Company, the operations on said account being managed by said Technical Operations function.

9: The process of claim 8 wherein incentive awarded shares of the Company are retained as shares in the general account of said establisher of Type 529 savings accounts to grow in value until being cashed in at close to the time of student bills to be paid and the proceeds deposited in selected established Type 529 accounts to comply with regulations that do not permit risk/reward holdings in said Type 529 accounts.

10: The process of claim 8 wherein said establisher disburses funds in timely fashion from said Type 529 accounts required by additional Regulations whereby said procedure followed by said establisher secured the Type 529 tax-free funding that benefited from growth outside the Type 529 Funds themselves through holding Company shares for an extended period of time in a permitted general account of the establisher.

11: The process of claim 1 wherein a recipient of incentive awards denominated as shares of the Company retains said shares in a general account provided by the Company rather than selling them and establishes one or more IRA savings accounts as available from the Company.

12: The process of claim 1 wherein a recipient of incentive awards denominated as shares of the Company funds from earnings said recipient's Roth IRA account annually with shares of the Company of value equal to the Regulation maximum deposit, and pays the income tax due that year on the value of the shares placed in said Roth IRA account, whereby said shares will be monetized, free of tax on invested principal and earnings thereon, after years of increase in value without restriction on how much at a time after reaching retirement age.

13: The process of claim 1 wherein a recipient of incentive awards denominated as shares of the Company funds from before-tax earnings his or her account annually with shares of the Company of value equal to the maximum deposit, whereby said shares will be monetized and tax paid on each annual withdrawal after years of increase in value, after retirement and subject to required minimum annual withdrawals of regulated value.

14: The process of claim 1 wherein said Business Entity is already active in credit card operations or enters the market sector by founding a bank or other financial entity or by purchasing an existing credit card business or by electing to conduct business with American Express, MasterCard, VISA or other existing credit card management company and provide incentive awards on credit cards on terms negotiated therewith or licenses the technology of the present invention to a business.

15: The process of claim 1 wherein said Business Entity operates a credit card issuing and management enterprise, negotiates with vendors and merchants desirous of accepting payment on said card and provides incentive awards for purchasers using said card and for the parties accepting said card.

16: The process of claim 15 wherein said parties accepting said card display a sign on their premises that indicates providing a new card on site and enabling a first transaction within minutes, said secure access being enabled by communications and computer electronics developed by said Technical Operations function for use in enrolment by the Company.

17: The process of claim 15 wherein said parties accepting payments via said cards are afforded the right to grant to award recipients larger incentive awards than are customary, of whatever percentage relative to purchase cost they may choose, subject to payment to the Company of a greater-than-customary fee as mutually agreed.

18: The process of claim 15 wherein the Business Entity grants all acceptors of payments made with its credit cards the right to reward themselves shares of the Company as incentive awards as they may choose, subject to a fee structure contracted with the Business Entity, thus enabling card acceptors to amass wealth and also causing a larger transaction to the benefit of the Business Entity and the Company.

19: The process of claim 1 wherein a recipient holding shares of the Company in a general account therewith is afforded the opportunity to pay by mutual consent a bill to another recipient holding shares of the Company in a general account, said payment being denominated as Company shares of value equal on the payment date to the cash value of the debt, whereby any profit on a mutually agreed settlement date is shared between the two parties.

20: The process of claim 1 wherein the Business Entity conducts a Lottery that involves purchase of chances denominated in cash or Company shares, and rewards winners with prizes denominated in cash or Company shares as an easily accessed recreational pursuit for incentive-awarded recipients who hold general accounts managed for the Company by the Technical Operations function.

21: The process of claim 1 wherein the Business Entity and an Enterprise operate a special type of Lottery that provides Company shares and Enterprise shares as prizes, said process enabling the Enterprise to benefit from exposure to awarded recipients registered with the Company and involving the Business Entity in a potentially lucrative activity with said Enterprise.
